(19) United States
(12) Patent Application Publication
(10) Pub. No.: US 2009/0100104 A1
(43) Pub. Date: Apr. 16, 2009

(54) SYSTEM AND METHOD FOR SUPPORTING ATTENDANCE AT A SPECTATOR EVENT

(76) Inventors: Jeffrey J. Kavlick, Aurora, OH (US); Gregory A. Johnson, Moreland Hills, OH (US); Scott L. Copeland, Cleveland, OH (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/248,242

(22) Filed: Oct. 9, 2008

Related U.S. Application Data
(60) Provisional application No. 60/979,410, filed on Oct. 12, 2007.

(51) Int. Cl. G06F 17/30

(52) U.S. Cl. 707/104.1; 707/E17.009

(57) ABSTRACT

A system and method for supporting attendance at spectator events are provided. Received selection data representative of a plurality of associated participants is associated with at least one general, pre-determined participant group, and associated with the team's and/or one or more player's performance related to the outcome of the particular attended sports event. Cumulative selection data is further collected in association with at least one general, pre-determined participant group and in association with the performance of a team and/or one or more player in a plurality of sports events. The collected cumulative selection data is then analyzed. Based on the analysis data representative of a reward for at least one participant or one participant group, is then output.

### CROSS REFERENCE TO RELATED APPLICATIONS

This application claims the benefit of priority from U.S. Provisional Application No. 60/979,410 filed on Oct. 12, 2007.

### BACKGROUND OF THE INVENTION

The subject application is directed to a system and method for supporting attendance at spectator events. More particularly, the subject application is directed to a system and method for supporting live attendance at sporting events, both professional and amateur, such as baseball, basketball, ice hockey, football, and the like. In particular, the subject application is directed to a system and method that merges affinity marketing with the performance of a competitive club, such as professional and collegiate sports teams, and with internet-based social networking, and provides maintaining of live and remote audience interest.

In recent years, the sports and entertainment industries have been experiencing rapid changes while continuing to be among the leading growth segments of the economy. As known in the art, economic impact is based on the theory that a dollar flowing into an economy, that otherwise would not have been spent, is a benefit to the economy. Thus, new spending in a local economy due to live attendance at an event leads to a change in the economy, which is measured in terms of total new spending, fiscal impact (total new taxes collected), personal income generated, and jobs created, both directly and indirectly. By increasing the new money in an economy, the economic benefit is serving a greater good by increasing government tax revenue, augmenting business income, and ultimately resulting in more jobs and higher personal income for residents of that economy.

Social networking web sites such as MySpace have become very popular. In addition to meeting other people and keeping in touch with existing friends and acquaintances, social networking has also developed into an effective medium for marketing goods and services.

### SUMMARY OF INVENTION

In accordance with the subject application, there is provided a system and method for supporting attendance at spectator events.

Further, in accordance with the subject application, there is provided a system and method for supporting live attendance at sporting events, both professional and amateur, such as baseball, basketball, ice hockey, football, and the like.

Still further, in accordance with the subject application, there is provided a system and method that merges affinity marketing with the performance of a competitive club, such as professional and collegiate sports teams and with internet-based social networking and provides maintaining of live and remote audience interest.

Further, in accordance with one embodiment of the subject application, there is provided a system for supporting live attendance at sporting events. The system includes means adapted for receiving selection data for each of a plurality of associated participants, such as fans, spectators, and the like. Those skilled in the art will appreciate that the selection data is capable of including identification data, demographic data with respect to a participant or multiple participants. The system further includes first association means adapted for associating selection data with respect to each of the plurality of participants with at least one general, pre-determined participant group, such as a hometown, school, church, employer, and the like. The system also includes second association means adapted for associating selection data with respect to each of the plurality of participants with a team's and/or one or more player's performance related to an outcome in the particular attended sports event. Further included in the system is a memory adapted for storing cumulative selection data in association with at least one general, pre-determined participant group and in association with the team's and/or one or more player's performance related to the outcome in a plurality of sports events. Further included in the system is cumulative means for collecting cumulative selection data in association with at least one general, pre-determined participant group and in association with the team's and/or one or more player's performance related to the outcome in a plurality of sports events. The system also includes analyzing means adapted for analyzing the collected cumulative selection data. Further included in the system is outputting means adapted for outputting data representative of a reward for at least one participant, or one participant group, based on the analysis of the cumulative selection data in association with at least one general, pre-determined participant group and in association with the team's and/or one or more player's performance related to the outcome in a plurality of sports events. For example, the analysis is capable of being based on attendance, events' records, and accumulated statistics.

In one embodiment of the subject application, the system further includes means adapted for prompting an associated participant for input of respective selection data. As will be recognized by those skilled in the art, this means is capable of being implemented as a kiosk or scanning location located inside the venue. In another embodiment, an associated participant is prompted to use an attendance tracking device, such as, for example, and without limitation, a magnetic strip card, radio-frequency identification card, or the like.

In one embodiment of the subject application, the system further includes means adapted for tracking and providing to a fan, lifetime attendance records and related performance results via a user interface.

In another embodiment of the subject application, the reward includes at least one of the group consisting of discounts/credits for sponsor-supported products, seat upgrades, scoreboard recognition, meeting with the team, player merchandise, and other rewards as appreciated by one skilled in the art.

In another embodiment of the subject application, the reward includes at least one of the group consisting of performance award for month/season, double wins/runs days, additional wins/runs credit for attending entire series, award for collecting one win each month of the season, and other rewards as appreciated by one skilled in the art.

In another embodiment of the subject application, additional rewards are capable of being collected at a website of an advertising sponsor.

In another embodiment of the subject application, the system further includes routing means adapted for routing content data via respective communication means to an associated participant. As will be appreciated by those skilled in the art, the content data is capable of including a periodic newsletter, reports representative of team and individual performance, scoreboard information, and the like. A skilled artisan will further appreciate that the content data is capable of being communicated to an associated participant via any suitable means known in the art, such as, for example and without limitation, email, phone communication, respective websites, or the like. Still other advantages, aspects and features of the subject application will become readily apparent to those skilled in the art from the following description wherein there are shown and described preferred embodiments of the subject application, simply by way of illustration of the best modes best suited for carrying out the invention. As it will be realized, the subject application is capable of other different embodiments and its several details are capable of modifications in various obvious aspects all without departing from the scope of the subject application. Accordingly, the drawings and description will be regarded as illustrative in nature and not as restrictive.

### BRIEF DESCRIPTION OF THE DRAWINGS

The accompanying drawings incorporated in and forming a part of the specification, illustrate several aspects of the subject application, and together with the description serve to explain the principles of the subject application. In the drawings:

FIG. 1 is an overall diagram of the system for a system for supporting live attendance at sporting events according to one embodiment of the subject application;

FIG. 2 is a block diagram illustrating device hardware for use in the system for supporting live attendance at sporting events according to one embodiment of the subject application;

FIG. 3 is a block diagram illustrating controller hardware for use in the system for supporting live attendance at sporting events according to one embodiment of the subject application;

FIG. 4 is a functional diagram illustrating the controller for use in the system for supporting live attendance at sporting events according to one embodiment of the subject application;

FIG. 5 is a representative architecture of the server for use in the system for supporting live attendance at sporting events according to one embodiment of the subject application;

FIG. 6 is a block diagram illustrating a system for supporting live attendance at sporting events according to one embodiment of the subject application.

FIG. 7 is a flowchart illustrating a method for supporting live attendance at sporting events according to one embodiment of the subject application.

### DETAILED DESCRIPTION OF THE PREFERRED EMBODIMENTS

The subject application is directed to a system and method for supporting attendance at spectator events. More particularly, the subject application is directed to a system and method for supporting live attendance at sporting events, both professional and amateur, such as baseball, basketball, ice hockey, football, and the like. In particular, the subject application is directed to a system and method that merges affinity marketing with the performance of a competitive club, such as professional and collegiate sports teams, and with internet-based social networking, and provides maintaining of live and remote audience interest.

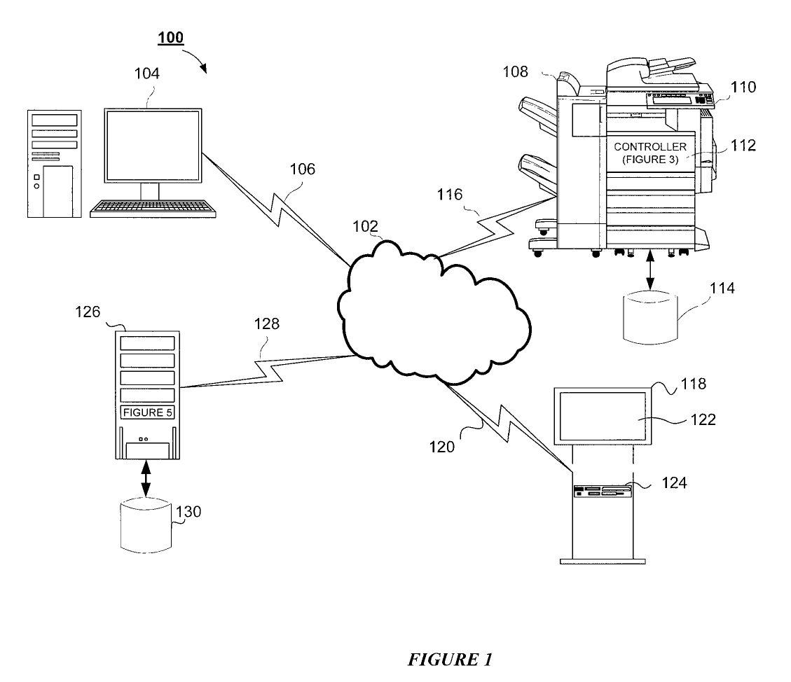

Referring now to FIG. 1, there is shown an overall diagram of the system 100 for supporting live attendance at sporting events in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

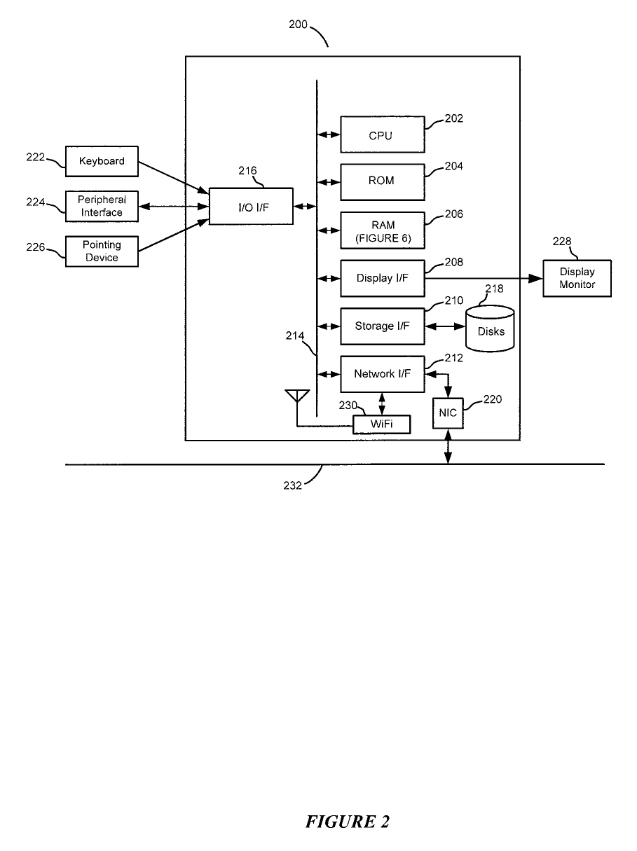

The system 100 illustrated in FIG. 1 further depicts a workstation 104, in data communication with the computer network 102 via a communications link 106. It will be appreciated by those skilled in the art that the workstation 104 is shown in FIG. 1 for illustration purposes only. As will be understood by those skilled in the art, the workstation 104 is representative of any personal computing or user device known in the art, including, for example and without limitation, a laptop computer, a personal computer, a personal data assistant, a web-enabled cellular telephone, a smart phone, a proprietary network device, or other web-enabled electronic device. The communications link 106 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 104 is suitably adapted for receiving selection data representative of a plurality of associated participants, such as fans, spectators, and the like, and associating the selection data with respect to each of the plurality of participants with at least one general, pre-determined participant group, such as a hometown, school, church, employer, and the like. The workstation 104 is further adapted for associating selection data with respect to each of the plurality of participants with the team's and/or one or more player's performance related to the outcome in a current sports event. The workstation 104 is further adapted for collecting cumulative selection data in association with at least one general, pre-determined participant group and in association with the team's and/or one or more player's performance related to the outcome in a plurality of sports events. The workstation 104 is yet further adapted for analyzing the cumulative selection data in association with at least one general, pre-determined participant group and in association with the team's and/or one or more player's performance related to the outcome in a plurality of sports events. The functioning of the workstation 104 will better be understood in conjunction with the block diagram illustrated in FIG. 2, explained in greater detail below.

As shown in FIG. 1, the system 100 also illustrates a document processing device 108, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, and the like. Those skilled in the art will appreciate that the document processing device 108 is capable of being implemented as any suitable device known in the art. In accordance with one aspect of the subject application, the document processing device 108 is suitably adapted to provide remote document processing services to external or network devices. Preferably, the document processing device 108 includes hardware, software, and any suitable combination thereof, configured to interact with an associated user, a networked device, and the like.

According to one embodiment of the subject application, the document processing device 108 is suitably equipped to receive a plurality of portable storage media, including, without limitation, Firewire drive, USB drive, SD, MMC, XD, Compact Flash, Memory Stick, or the like. In the preferred embodiment of the subject application, the document processing device 108 further includes an associated user interface 110, such as a touch-screen, LCD display, touch-panel, alpha-numeric keypad, and the like, via which an associated user is able to interact directly with the document processing device 108. In accordance with the preferred embodiment of the subject application, the user interface 110 is advantageously used to communicate information to the associated user and receive selections from the associated user. The skilled artisan will appreciate that the user interface 110 comprises various components, suitably adapted to present data to the associated user, as are known in the art. In accordance with one embodiment of the subject application, the user interface 110 comprises a display, suitably adapted to display one or more graphical elements, text data, images, and the like, to an associated user, receive input from the associated user, and communicate the same to a backend component, such as a controller 112, as explained in greater detail below. Preferably, the document processing device 108 is communicatively coupled to the computer network 102 via a suitable communications link 116. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

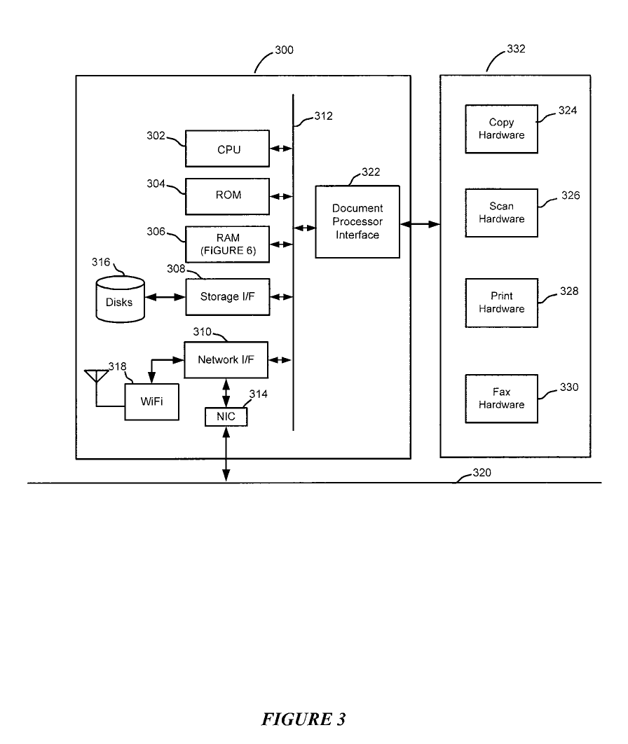

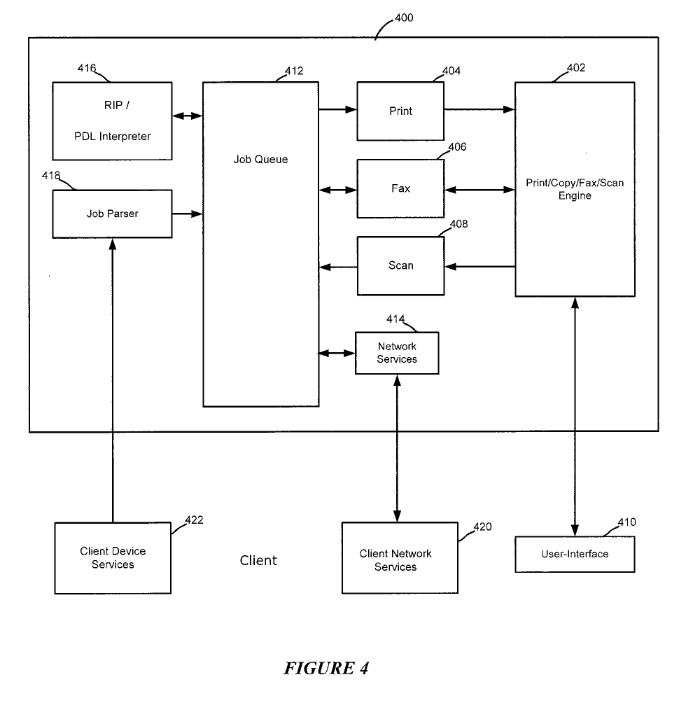

In accordance with one embodiment of the subject application, the document processing device 108 further incorporates a backend component, designated as the controller 112, suitably adapted to facilitate the operations of the document processing device 108, as will be understood by those skilled in the art. Preferably, the controller 112 is embodied as hardware, software, or any suitable combination thereof, configured to control the operations of the associated document processing device 108, facilitate the display of images via the user interface 110, direct the manipulation of electronic image data, and the like. For purposes of explanation, the controller 112 is used to refer to any myriad of components associated with the document processing device 108, including hardware, software, or combinations thereof, functioning to perform, cause to be performed, control, or otherwise direct the methodologies described hereinafter. It will be understood by those skilled in the art that the methodologies described with respect to the controller 112 are capable of being performed by any general purpose computing system, known in the art, and thus the controller 112 is representative of such a general computing device and is intended as such when used hereinafter. Furthermore, the use of the controller 112 hereinafter is for the example embodiment only, and other embodiments, which will be apparent to one skilled in the art, are capable of employing the system and method for supporting live attendance at sporting events. The functioning of the controller 112 will better be understood in conjunction with the block diagrams illustrated in FIGS. 3 and 4, explained in greater detail below.

The system 100 further includes a data storage device 114, which in the embodiment illustrated in FIG. 1 is communicatively coupled to the document processing device 108. Those skilled in the art will appreciate that the data storage device 114 is equally capable of being communicatively coupled to the workstation 104. A skilled artisan will further appreciate that the data storage device 114 is also capable of being an internal device of the workstation 104 or of the document processing device 108. In accordance with the preferred embodiment of the subject application, the data storage device 114 is any mass storage device known in the art including, for example and without limitation, magnetic storage drives, a hard disk drive, optical storage devices, flash memory devices, or any suitable combination thereof. In the preferred embodiment, the data storage device 114 is suitably adapted for storing data with respect to supporting live attendance at sporting events, such as, for example, and without limitation, cumulative selection data in association with at least one general, pre-determined participant group and in association with the team's and/or one or more player's performance related to the outcome in a plurality of sports events. As will be appreciated by those skilled in the art, the data storage device 114 is also capable of implementation as a Storage Area Network (SAN).

It will be appreciated by those skilled in the art that while illustrated in FIG. 1 as being a separate component of the system 100 coupled to the document processing device 108, the data storage device 114 is capable of being implemented as internal storage component of the document processing device 108, a component of the controller 112, or the like, such as, for example and without limitation, an internal hard disk drive, and the like. As will be further recognized by a skilled artisan, the data storage device 114 is also capable of being coupled to the workstation 104 (not shown in the drawing), or implemented as internal storage component of the workstation 104, such as, for example and without limitation, an internal hard disk drive.

Illustrated in FIG. 1 is a kiosk 118, in data communication with the computer network 102 via a communications link 120. It will be appreciated by those skilled in the art that the kiosk 118 is capable of being implemented as a separate component, or as an integral component of the workstation 104. Use of the kiosk 118 in FIG. 1 is for example purposes only, and the skilled artisan will appreciate that the subject application is capable of implementation without the use of kiosk. In accordance with one embodiment of the subject application, the kiosk 118 includes a user interface/display 122, hereinafter display 122, and a portable media reader 124. In accordance with on embodiment of the subject application, the display 122 is representative of any touch screen interface known in the art and the use of the display 122 in the subject application context is solely for example purposes.

According to one embodiment of the subject application, the kiosk 118 is suitably adapted to display prompts to an associated participant, receive instructions from the associated participant, receive payment data, receive selection data from an associated participant. As will be appreciated by those skilled in the art, the kiosk 118 is suitably adapted to receive selection data for each of a plurality of associated participants, which selection data is capable of including identification data, demographic data with respect to a participant or multiple participants. The kiosk 118 is advantageously capable of prompting an associated participant to use an attendance tracking device, such as a magnetic strip card, radio-frequency identification card, or the like. Preferably, the kiosk 118 is suitably adapted to receive a portable data device, such as a magnetic data storage device, universal serial bus storage, smart card, flash storage device, disk storage device, non-volatile storage device, credit card, and the like. Thus, the skilled artisan will appreciate that in accordance with such an embodiment, the portable media reader 124 includes a magnetic card reader, conventional bar code reader, or the like, suitably adapted to receive and read data from a portable data device.

The system 100 of FIG. 1 further includes a server 126, communicatively coupled to the computer network 102 via a communications link 128. It will be appreciated by those skilled in the art that the server 126 comprises hardware, software, and combinations thereof suitably adapted to provide one or more services, web-base applications, storage options, or the like, to networked devices. In accordance with one embodiment of the subject application, the server 126 includes various components, implemented as hardware, software, or a combination thereof, for managing the performance of web services processes accessed via the computer network 102. The communications link 128 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. The functioning of the server 126 will better be understood in conjunction with the block diagrams illustrated in FIG. 4, explained in greater detail below.

Communicatively coupled to the server 126 is a data storage device 130. In accordance with the preferred embodiment of the subject application, the data storage device 130 is any mass storage device known in the art including, for example and without limitation, magnetic storage drives, a hard disk drive, optical storage devices, flash memory devices, or any suitable combination thereof. In the preferred embodiment, the data storage device 130 is suitably adapted to store identification data, demographic data with respect to multiple participants, cumulative data in association with a plurality of sports events, update lists, electronic database data, document data, image data, or the like. It will be appreciated by those skilled in the art that while illustrated in FIG. 1 as being a separate component of the system 100, the data storage device 130 is capable of being implemented as internal storage component of the server 120, or the like, such as, for example and without limitation, an internal hard disk drive, or the like. As will be recognized by a skilled artisan, the data storage device 130 is also capable of implementation as a Storage Area Network (SAN). In one embodiment of the subject application, the system 100 further includes routing means adapted for routing content data via respective communication means to an associated participant (not shown in the drawing). As will be appreciated by those skilled in the art, the content data is capable of including a periodic newsletter, reports representative of team and individual performance, scoreboard information, and the like. A skilled artisan will further appreciate that content data may be sent to participants to offer discounts, communicate gratitude, or for other reasons as a result of a participant registering attendance at a particular event. A skilled artisan will further appreciate that the content data is capable of being communicated to an associated participant via any suitable means known in the art, such as email, phone communication, text messages, respective websites, or the like (not shown).

Turning now to FIG. 2, illustrated is a representative architecture of a suitable device 200 on which operations of the subject system are completed. Included is a processor unit 202 s which is advantageously placed in data communication with read only memory 204, suitable non-volatile read only memory, volatile read only memory or a combination thereof, random access memory 206, display interface 208, storage interface 210, and network interface 212. In a preferred embodiment, interface to the foregoing modules is suitably accomplished via a bus 214.

The read only memory 204 suitably includes firmware, such as static data or fixed instructions, such as BIOS, system functions, configuration data, and other routines used for operation of the server 200 via CPU 202.

The random access memory 206 provides a storage area for data and instructions associated with applications and data handling accomplished by the processor 202.

The display interface 208 receives data or instructions from other components on the bus 214, which data is specific to generating a display to facilitate a user interface. The display interface 208 suitably provides output to a display terminal 226, suitably a video display device such as a monitor, LCD, plasma, or any other suitable visual output device as will be appreciated by one of ordinary skill in the art.

The storage interface 210 suitably provides a mechanism for non-volatile, bulk or long term storage of data or instructions in the server 200. The storage interface 210 suitably uses a storage mechanism, such as storage 218, suitably comprised of a disk, tape, CD, DVD, or other relatively higher capacity addressable or serial storage medium.

The network interface 212 suitably communicates to at least one other network interface, shown as network interface 220, such as a network interface card, and wireless network interface 230, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 220 is interconnected for data interchange via a physical network 232, suitably comprised of a local area network, wide area network, or a combination thereof.

An input/output interface 216 in data communication with the bus 214 is suitably connected with an input device 222, such as a keyboard and the like. The input/output interface 216 also suitably provides data output to a peripheral interface 224, such as a USB, universal serial bus output, SCSI, Firewire (IEEE 1394) output, or any other interface as may be appropriate for a selected application. Finally, the input/output interface 216 is suitably in data communication with a pointing device interface 228 for connection with devices, such as a mouse, light pen, touch screen, and the like.

Turning now to FIG. 3, illustrated is a representative architecture of a suitable backend component, i.e., the controller 300, shown in FIG. 1 as the controller 112, on which operations of the subject system 100 are completed. The skilled artisan will understand that the controller 112 is representative of any general computing device, known in the art, capable of facilitating the methodologies described herein. Included is a processor 302, suitably comprised of a central processor unit. However, it will be appreciated that processor 302 may advantageously be composed of multiple processors working in concert with one another as will be appreciated by one of ordinary skill in the art. Also included is a non-volatile or read only memory 304 which is advantageously used for static or fixed data or instructions, such as BIOS functions, system functions, system configuration data, and other routines or data used for operation of the controller 112.

Also included in the controller 300 is random access memory 306, suitably formed of dynamic random access memory, static random access memory, or any other suitable, addressable and writable memory system. Random access memory provides a storage area for data instructions associated with applications and data handling accomplished by processor 302.

A storage interface 308 suitably provides a mechanism for non-volatile, bulk or long term storage of data associated with the controller 300. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the controller 300 to communicate to other devices. The network interface subsystem 310 suitably interfaces with one or more connections with external devices to the device 300. By way of example, illustrated is at least one network interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 314 is interconnected for data interchange via a physical network 320, suitably comprised of a local area network, wide area network, or a combination thereof.

Data communication between the processor 302, read only memory 304, random access memory 306, storage interface 308 and the network interface subsystem 310 is suitably accomplished via a bus data transfer mechanism, such as illustrated by bus 312.

Also in data communication with bus the 312 is a document processor interface 322. The document processor interface 322 suitably provides connection with hardware 332 to perform one or more document processing operations. Such operations include copying accomplished via copy hardware 324, scanning accomplished via scan hardware 326, printing accomplished via print hardware 328, and facsimile communication accomplished via facsimile hardware 330. It is to be appreciated that the controller 300 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 108, which includes the controller 300 of FIG. 3, (shown in FIG. 1 as the controller 112) as an intelligent subsystem associated with a document processing device. In the illustration of FIG. 4, controller function 400 in the preferred embodiment, includes a document processing engine 402. FIG. 4 illustrates suitable functionality of the hardware of FIG. 3 in connection with software and operating system functionality as will be appreciated by one of ordinary skill in the art.

In the preferred embodiment, the engine 402 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 402 is suitably interfaced to a user interface panel 410, which panel allows for a user or administrator to access functionality controlled by the engine 402. Access is suitably enabled via an interface local to the controller, or remotely via a remote thin or thick client.

The engine 402 is in data communication with the print function 404, facsimile function 406, and scan function 408. These functions facilitate the actual operation of printing, facsimile transmission and reception, and document scanning for use in securing document images for copying or generating electronic versions.

A job queue 412 is suitably in data communication with the print function 404, facsimile function 406, and scan function 408. It will be appreciated that various image forms, such as bit map, page description language or vector format, and the like, are suitably relayed from the scan function 408 for subsequent handling via the job queue 412.

The job queue 412 is also in data communication with network services 414. In a preferred embodiment, job control, status data, or electronic document data is exchanged between the job queue 412 and the network services 414. Thus, suitable interface is provided for network based access to the controller function 400 via client side network services 420, which is any suitable thin or thick client. In the preferred embodiment, the web services access is suitably accomplished via a hypertext transfer protocol, file transfer protocol, uniform data diagram protocol, or any other suitable exchange mechanism. The network services 414 also advantageously supplies data interchange with client side services 420 for communication via FTP, electronic mail, TELNET, and the like. Thus, the controller function 400 facilitates output or receipt of electronic document and user information via various network access mechanisms.

The job queue 412 is also advantageously placed in data communication with an image processor 416. The image processor 416 is suitably a raster image process, page description language interpreter or any suitable mechanism for interchange of an electronic document to a format better suited for interchange with device functions such as print 404, facsimile 406 or scan 408.

Finally, the job queue 412 is in data communication with a parser 418, which parser suitably functions to receive print job language files from an external device, such as client device services 422. The client device services 422 suitably include printing, facsimile transmission, or other suitable input of an electronic document for which handling by the controller function 400 is advantageous. The parser 418 functions to interpret a received electronic document file and relay it to the job queue 412 for handling in connection with the afore-described functionality and components.

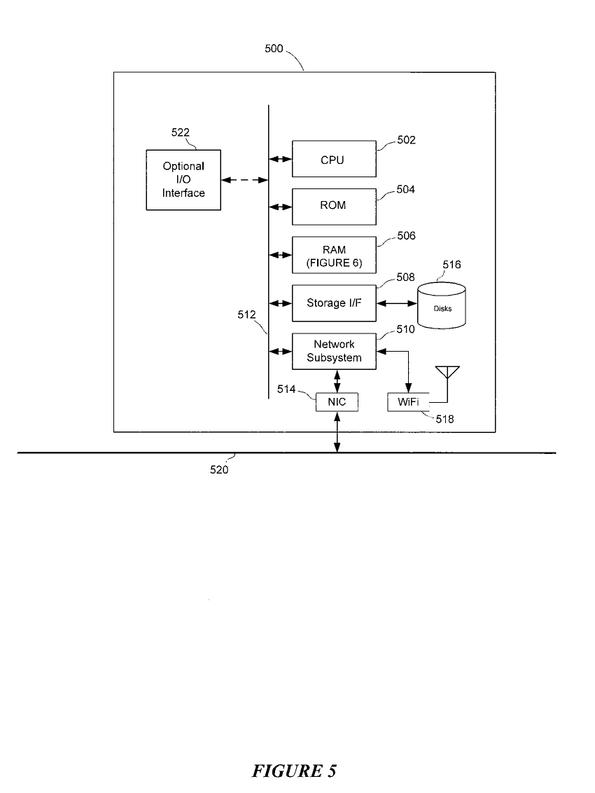

Turning now to FIG. 5, illustrated is a representative architecture of a suitable server 500, depicted in FIG. 1 as the server 126, on which operations of the subject system are completed. Included is a processor 502, suitably comprised of a central processor unit. However, it will be appreciated that processor 502 may advantageously be composed of multiple processors working in concert with one another as will be appreciated by one of ordinary skill in the art. Also included is a non-volatile or read only memory 504 which is advantageously used for static or fixed data or instructions, such as BIOS functions, system functions, system configuration, and other routines or data used for operation of the server 400.

Also included in the server 500 is random access memory 506, suitably formed of dynamic random access memory, static random access memory, or any other suitable, addressable memory system. Random access memory provides a storage area for data instructions associated with applications and data handling accomplished by the processor 502.

A storage interface 508 suitably provides a mechanism for volatile, bulk or long term storage of data associated with the server 500. The storage interface 508 suitably uses bulk storage, such as any suitable addressable or serial storage, such as a disk, optical, tape drive and the like as shown as 516, as well as any suitable storage medium as will be appreciated by one of ordinary skill in the art.

A network interface subsystem 510 suitably routes input and output from an associated network allowing the server 500 to communicate to other devices. The network interface subsystem 510 suitably interfaces with one or more connections with external devices to the server 500. By way of example, illustrated is at least one network interface card 514 for data communication with fixed or wired networks, such as Ethernet, token ring, and the like, and a wireless interface 518, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 520, suitably comprised of a local area network, wide area network, or a combination thereof.

Data communication between the processor 502, read only memory 504, random access memory 506, storage interface 508 and the network subsystem 510 is suitably accomplished via a bus data transfer mechanism, such as illustrated by bus 512.

Suitable executable instructions on the server 500 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 522 as will be appreciated by one of ordinary skill in the art.

In operation, selection data for each of a plurality of associated participants is first received. Those skilled in the art will appreciate that selection data is capable of including identification data, demographic data with respect to each of a plurality of participants, and the like. Next, the received selection data with respect to each of the plurality of participants is associated with at least one general, pre-determined participant group, such as a hometown, school, church, employer, and the like, and further associated with the team's and/or one or more player's performance related to the outcome in the particular attended sports event. The selection data, in association with at least one general, pre-determined participant group, such as a hometown, school, church, employer, and the like, and in association with the team's and/or one or more player's performance related to the outcome in the particularly attended sports event, is then stored in a memory. Cumulative selection data is further collected in association with at least one general, pre-determined participant group and in association with the team's and/or one or more player's performance related to the outcome in the particularly attended plurality of sports events. The collected cumulative selection data in association with at least one general, pre-determined participant group and in association with the team's and/or one or more player's performance related to the outcome in the particularly attended plurality of sports events, is then analyzed. Next, a reward for at least one participant is output based upon the analyzed data. In one example, a reward is output for an entire participant group. For example, all members of a particular church may receive an award.

In accordance with one example embodiment of the subject application, the workstation 104 receives selection data for each of a plurality of associated participants, such as fans, spectators, and the like. Those skilled in the art will appreciate that selection data is capable of being received directly at the workstation 104 or via the kiosk 118. With respect to FIG. 1, selection data including identification data, demographic data with respect to a participant, or multiple participants, is received via the kiosk 118, which is adapted for prompting an associated participant for input of respective selection data. In another embodiment, an associated participant is prompted to use an attendance tracking device, such as a magnetic strip card, radio-frequency identification card, or the like (not shown). Selection data is then stored in a memory associated with a respective component of the system 100, such as data storage device 114, data storage device 130, or respective internal memory associated therewith.

A component of the server 126 associates selection data with respect to each of the plurality of participants with at least one general, pre-determined participant group, such as a hometown, school, church, employer, or the like. A suitable component associated with the server 126, then associates selection data with respect to each of the plurality of participants with the team's and/or one or more player's performance related to the outcome in the particularly attended sports event. Cumulative selection data in association with at least one general, pre-determined participant group and in association with the team's and/or one or more player's performance related to the outcome in the particularly attended plurality of sports events, is then collected by a component of the server 126. Next, cumulative selection data in association with at least one general, pre-determined participant group and in association with the team's and/or one or more player's performance related to the outcome in the particularly attended plurality of sports events, is stored in a respective data storage device, such as the storage device 130, or storage device 114.

The server 126 then analyzes the cumulative selection data in association with at least one general, pre-determined participant group and in association the team's and/or one or more player's performance related to the outcome in the particularly attended plurality of sports events. For example, the analysis is capable of being based on attendance, events' records, and accumulated statistics. The associating steps, as well as the analysis of the cumulative selection data are described herein as being performed by the server 126. However, as will be appreciated by those skilled in the art, these steps are advantageously capable of being performed by the workstation 104, or any suitable component associated therewith. Based on the analysis, output data representative of a reward for at least one participant, or one participant group, is output by the server 126.

As will be appreciated by those skilled in the art, output data is capable of being output to the workstation 104 via the network 102 to serve up web pages. In one embodiment output data representative of a reward for at least one participant, or one participant group, is out put for printing via the document processing device 108.

In one embodiment, receiving and analyzing the cumulative selection data is capable of being performed in association with at least one general, pre-determined participant group and in association the performance of at least one team member related to the outcome in the particularly attended one, or plurality of sports events. Respective reward data is then output by the server 126.

In one embodiment, the reward includes at least one of the group consisting of discounts/credits for sponsor-supported products, seat upgrades, scoreboard recognition, meeting with the team, player merchandise, or other rewards as appreciated by one skilled in the art. In another embodiment, the reward includes at least one of the group consisting of performance award for month/season, double wins/runs days, additional wins/runs credit for attending entire series, award for collecting one win each month of the season, and other rewards as appreciated by one skilled in the art. Those skilled in the art will recognize that respective reward data is then advantageously output by the server 126. In yet another embodiment of the subject application, additional rewards are capable of being collected at a website of an advertising sponsor.

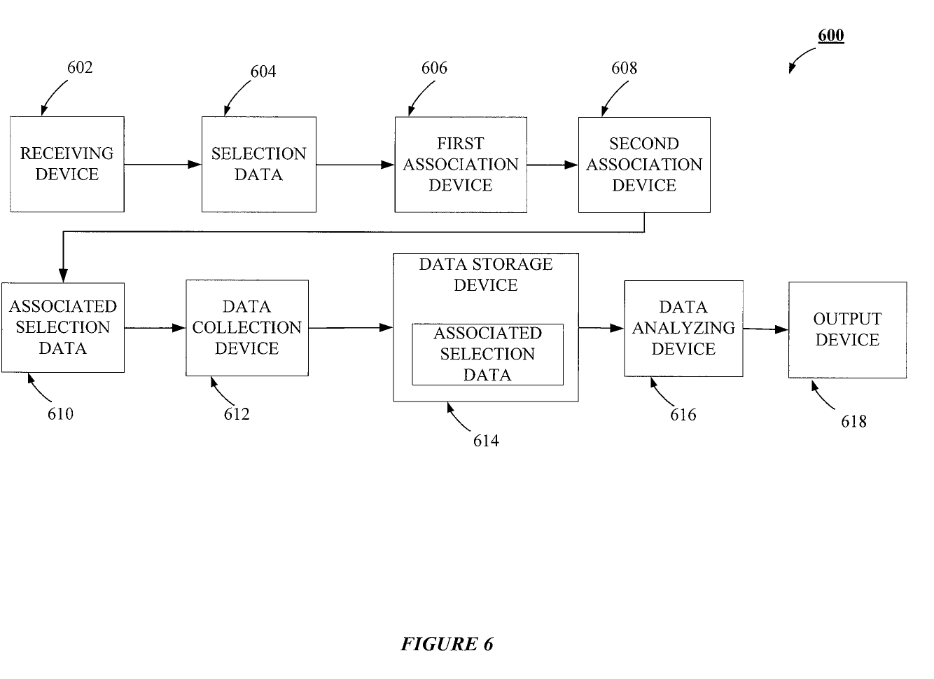

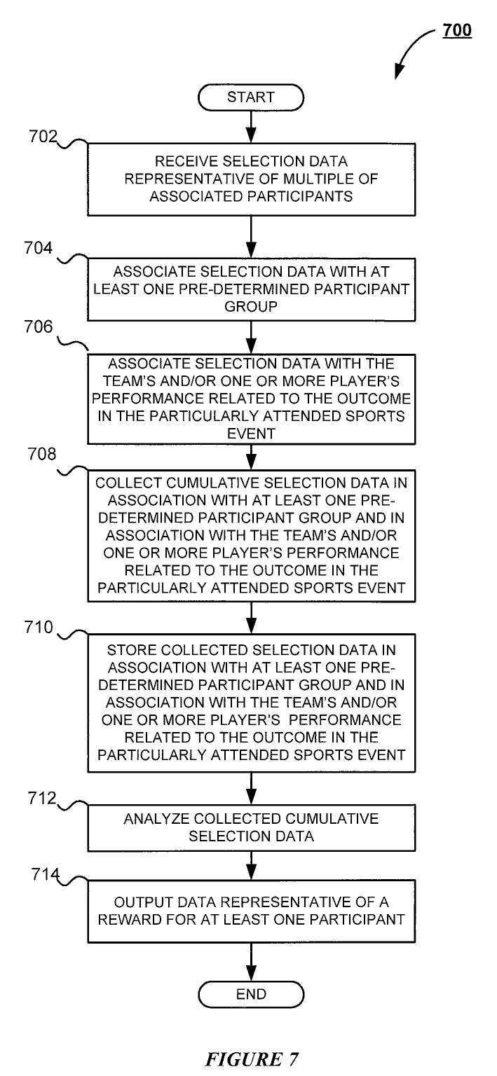

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and 7.

Turning now to FIG. 6, there is shown a block diagram illustrating a system 600 for supporting live attendance at sporting events. The receiving device 602 receives selection data 604 for each of a plurality of associated participants, such as fans, spectators, and the like. In one embodiment, the receiving device is a kiosk 118, which is adapted for prompting an associated participant for input of respective selection data. Those skilled in the art will appreciate that the selection data is capable of including identification data, demographic data with respect to a participant, or multiple participants In another embodiment, an associated participant is prompted to use an attendance tracking device, such as a magnetic strip card, radio-frequency identification card, or the like (not shown).

Next, first association device 606 associates selection data 604 with respect to each of the plurality of participants with at least one general, pre-determined participant group, such as a hometown, school, church, employer, or the like. Second association device 608 associates selection data 604 with respect to each of the plurality of participants with the team's and/or one or more player's performance related to the outcome in the particularly attended sports event. Data collection device 612 collects associated selection data 610. Data storage device 614 stores the collected data. Data analyzing device 616 analyzes the stored associated selection data. For example, data analyzer 616 is capable of analyzing based on attendance, events' records, and accumulated statistics. Based on the analysis output data representative of a reward for at least one participant, or one participant group, is output by output device 618. As will be appreciated by those skilled in the art, output data is capable of being output to the workstation 104 via the network 102 to serve up web pages. In one embodiment output data representative of a reward for at least one participant or one participant group, is output for printing via the document processing device 108.

In one embodiment, score tracking is provided by groups and by individual participants. For example, when an individual's score reaches a certain level, a reward is provided to that particular individual only. In another example, when a certain group's score reaches a certain level, rewards are provided to all individual participants associated with the group. In another embodiment, lifetime attendance records and related performance results will be tracked and provided to a participant via a user interface. For example, a kiosk may provide a participant with a detailed record of all past events attended as well as the results of the event including whether the home team was victorious and how individual players performed during the event. One skilled in the art will appreciate other forms of user interfaces for providing information to a participant.

Turning now to FIG. 7, there is shown a flowchart 700 illustrating a method for supporting live attendance at sporting events. Beginning at step 702, the workstation 104 receives selection data for each of a plurality of associated participants, such as fans, spectators, and the like. In one embodiment, selection data is received via the kiosk 118, which is adapted for prompting an associated participant for input of respective selection data. Those skilled in the art will appreciate that the selection data is capable of including identification data, demographic data with respect to a participant, or multiple participants In another embodiment, an associated participant is prompted to use an attendance tracking device, such as a magnetic strip card, radio-frequency identification card, or the like (not shown).

Flow then proceeds to step 704, whereupon a component of the server 126 associates selection data with respect to each of the plurality of participants with at least one general, pre-determined participant group, such as a hometown, school, church, employer, or the like. At step 706, a suitable component associated with the server 126, associates selection data with respect to each of the plurality of participants with the team's and/or one or more player's performance related to the outcome in the particularly attended sports event. Flow then proceeds to step 708, at which step cumulative selection data in association with at least one general, pre-determined participant group and in association with the team's and/or one or more player's performance related to the outcome in the particularly attended plurality of sports events, is collected by a component of the server 126. Collected cumulative selection data is then stored at step 710 in the data storage device 130 and analyzed at step 712. For example, the analysis is capable of being based on attendance, events' records, and accumulated statistics. Based on the analysis, output data for each of a reward for at least one participant, or one participant group, is output at step 714 by the server 126. As will be appreciated by those skilled in the art, output data is capable of being output at step 714 to the workstation 104 via the network 102 to serve up web pages. In one embodiment output data representative of a reward for at least one participant or one participant group, is out put for printing via the document processing device 108. In one embodiment, score tracking is provided by groups and by individual participants. In another embodiment, lifetime attendance records and related performance results will be tracked and provided to a participant via a user interface.

As described herein, the system and method of the subject application provide supporting of attendance at spectator events, support the creation and selection of participant groups that represent group leagues for employers, schools, companies, season ticket holders, and the like. Program sponsors may offer prizes to fans for team record and various statistics amassed by the sponsor's club during games attended. As will be appreciated by those skilled in the art, the subject application will encourage general attendance, and will establish a deeper connection between a fan, the team, and attendance. The subject application provides sponsors with the ability to drive daily and seasonal marketing efforts for selecting dates and events. The subject application also provides sponsors with the ability to offer as-desired programs on a daily, weekly, seasonal, annual, or other basis to encourage attendance at events. Such programs can include bonus points, removal of losses from a participant's record, or point multipliers for consecutive performances such as numbers of recorded wins in row or consecutive events attended by a participant. Such programs may be implemented via an administrative interface to the application provided to sponsors or provided to administrators of the subject application. An administrative interface allows a sponsor or an administrator to add, modify, or remove such programs. In addition, the system is capable of collecting demographics and attendance patterns (“CRM Data”) that will be used to support the sales and marketing efforts of leagues, teams, and conferences. Group setup, competition, and awards are, preferably, provided by a sponsor, but also are capable of being managed by the fan base.

In one embodiment, the subject application is merged with internet-based social networking. Social networking allows individuals or groups to connect to other individuals or groups for the purpose of maintaining or developing new social relationships. The Internet enables individuals to socially network that would otherwise not be able to or would have a difficult time doing so due to geographic separation. The Internet also enables individuals within the same geographic region to more easily and efficiently maintain relationships. Internet-based social networking has also been used as a medium for sharing ideas, advertising products and services, and other such functions. By merging with internet-based social networking, the system gives participants the ability to link their accounts to others to form competitive groups. For example, two participants may not be associated with the same group by the system but may nevertheless chose to be associated with one another for competitive purposes. An integrated social network allows the two participants to discover one another and link their accounts as if they were associated with the same group. Similarly, one group may chose to link to and compete with a second group. An integrated social network allows two groups to link as well. A participant may have several relationships maintained with other non-participants through an internat-based social network. Merging the subject application with an internet-based social network enables a participant to easily invite those non-participants to become participants. Further, the system encourages participants to invite non-participants to join by tracking when invited non-participants accept invitations and giving the inviting participants credit.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application.

What is claimed:

1. A method for supporting live attendance at a sporting event comprising:
receiving selection data from each of a plurality of associated participants attending a sporting event;
associating the selection data with a predetermined participant group;
associating the selection data with at least one of a team's performance and a player's performance related to the outcome of an attended sporting event;
collecting the selection data in association with at least one predetermined participant group and in association with at least one of a team's performance and a player's performance;
storing the collected data;
analyzing the stored data; and
outputting data representative of a reward for at least on participant.

2. The method of claim 1, wherein the selection data comprises identification data and demographic data of the plurality of associated participants.

3. The method of claim 1, further comprising prompting an associated participant for input of respective selection data via an associated user interface.

4. The method of claim 1, wherein the selection data is received via an attendance tracking device.

5. The method of claim 4, wherein the attendance tracking device is a magnetic strip card.

6. The method of claim 4, wherein the attendance tracking device is a radio frequency identification card.

7. The method of claim 1, wherein data is displayed via a workstation coupled to a network.

8. The method of claim 1, wherein data is output as a tangible medium via a document processing device.

9. A system for supporting live attendance at a sporting event comprising:
a receiving device for receiving selection data from each of a plurality of associated participants attending a sporting event;
a first association device for associating the selection data with a predetermined participant group;
a second association device for associating the selection data with at least one of a team or a player's performance related to the outcome of an attended sporting event;
a data collection device for collecting the selection data in association with at least one predetermined participant group and in association with at least one of a team's performance and a player's performance;
a data storage device for storing the collected data;
a data analyzing device for analyzing the stored data; and
an output device for outputting data representative of a reward for at least on participant.

10. The system of claim 9, wherein the selection data comprises identification data and demographic data of the plurality of participants.

11. The system of claim 9, wherein the receiving device is a kiosk configured to prompt an associated participant for input of respective selection data.

12. The system of claim 9, wherein the receiving device is an attendance tracking device.

13. The system of claim 9, wherein the output device is configured to display data via a display in a workstation.

14. The system of claim 9, wherein the output device is configured to output data via a document processing device.

15. A system for supporting live attendance at a sporting event comprising:
Means adapted for receiving selection data representative of a plurality of participants attending a sporting event;
means adapted for associating the selection data with a predetermined participant group;
means adapted for associating the selection data with at least one of a team or a player's performance related to the outcome of an attended sporting event;
means adapted for collecting the selection data in association with at least one predetermined participant group and in association with at least one of a team's performance and a player's performance;
means adapted for storing the collected data;
means adapted for analyzing the stored data; and
means adapted for outputting data representative of a reward for at least on participant.

16. The system of claim 15, wherein the selection data comprises identification data and demographic data of the plurality of participants.

17. The system of claim 15, further comprising means for prompting an associated participant for input of respective selection data via an associated user interface.

18. The system of claim 15, wherein the means for outputting data is configured to display data via a display in a workstation.

19. The system of claim 15, wherein the means for outputting data is configured to output data for printing via a document processing device.
